(19) United States
(12) Patent Application Publication
(10) Pub. No.: US 2016/0227752 A1
(43) Pub. Date: Aug. 11, 2016

(54) Baiting Apparatus for Catching Crabs

(71) Applicant: Vincent Sindelar, Brentwood, NY (US)

(72) Inventor: Vincent Sindelar, Brentwood, NY (US)

(21) Appl. No.: 15/010,048

(22) Filed: Jan. 29, 2016

Related U.S. Application Data
(60) Provisional application No. 62/114,405, filed on Feb. 10, 2015.

(51) Int. Cl. A01K 91/18

(52) U.S. Cl. CPC A01K 91/18

(57) ABSTRACT

A crab lure is disclosed that permits a crabber may to use an ordinary fishing rod, reel and fishing line to easily cast the crab lure away from the crabber's standing position. As crab lure strikes the surface of the water, the lure's flared tube with baited, spring-loaded clip may gradually slide freely down the line, toward the bottom, leaving the lure's float at the surface. The crab lure enables the crabber to lift bait from the bottom, while allowing the crab to freely move with the bait, and away from obstructions encountered on the bottom, and prevents the bait from being dragged on the bottom and potentially damaged or released from the baiting apparatus. Movement of the float and/or tension on the line will let the crabber know that a crab has latched onto the bait.

### CROSS REFERENCE TO RELATED APPLICATIONS

This application claims the benefit of U.S. Provisional Patent Application No. 62/114,405 filed Feb. 10, 2015 entitled Baiting Apparatus for Catching Crabs, which is incorporated by reference herein.

### FIELD OF THE INVENTION

The present invention relates generally to the field of fishing in general, and crab fishing in particular. The present invention refers to an apparatus for recreational crab fishing.

### BACKGROUND OF THE INVENTION

Crab fishing is an enjoyable outdoor activity that can be fun for the family, or even become a commercial business. Fishing for crabs, or “crabbing” involves catching and eating the succulent crustaceans that inhabit salt water. Crab most commonly caught and eaten along the East Coast of the United States are known as the blue claw crab. There is nothing better than coming home and having a delicious meal of steamed blue claw crabs with OLD BAY™ seasoning for the family.

Some think that eating a cooked crab is a difficult process. But, perhaps even more difficult and time consuming is the process of catching a crab. Although crabs are generally found in saltwater, they may also inhabit brackish water, also known as tidal water. These areas include saltwater marshes, bays, inlets and the ocean. Crabs prefer to be near underwater structures such as pilings (usually from docks), bridges and sunken shipwrecks. Docks and bridges generally provide the ideal location for crabbing. However, there has not been much in the way of progress concerning apparatus that people can use to catch crabs.

Generally, the prior art methods of crabbing comprise either the use of a crab pot, crab net/trap or baited twine. Crabpots are ingenious contraptions that use a crab's very own escape instincts to trap them. Crabpots are typically baited with eel, bull lip, Menhaden (bunker), chicken or turkey necks, or other types of inexpensive meat that attract crabs. Crabs smell the bait and circle the pot, entering through one of the openings in the crabpot. Once inside and unable to reach the bait, the crab feels trapped and threatened. When threatened, a crab instinctively swims up towards the surface to escape, where it winds up inside a “parlor.” The crab remains in the parlor until a crabber brings the crabpot to the surface and removes the crab through an opening along a top edge of the parlor. Most crab pots have two small exit holes up high in the parlor called “cull rings.” These rings are big enough to let small crabs escape yet small enough to trap the larger “keepers.”

A crab trap is less sophisticated than a crabpot, being merely a cage with pivoting sides, sometimes referred to as a pyramid or box trap. A crab net, or ring net, is similar in design, but comprises sides made from flexible line mesh rather than rigid steel mesh. A crab net is deployed in the same manner as a crab trap, and will not be discussed further. Like a crabpot, a crabber baits the trap. The crabber releases the trap into the bottom, where the sides fall down, permitting the crab access to the bait. Periodically, a crabber will remove the trap from the water by retrieving the line, which is usually secured to a buoy or tied off at the dock. As the trap is lifted, the sides capture any crabs feasting on the bait.

Perhaps the simplest prior art crabbing apparatus is a baited twine. To one end of the twine, a crabber ties bait, such as a chicken or turkey neck, sometimes placed within a stocking, or alternatively, a punctured can of cat food. The crabber lowers the baited twine to the bottom, where the crab finds it. Then the crabber periodically will gradually and carefully lift the bait by the twine to the surface of the water. Crabs are greedy and generally will not let go when latched onto the bait. However, some crabs, especially the older, wiser and bigger ones, may sense danger as they are being brought to the surface by seeing the crabber's shadow, or seeing a bright object near the surface, like an improperly clothed crabber. A seasoned crabber will quickly and deftly scoop a large crab with a long pole dip net, and deposit it into a waiting bucket or preferably an iced cooler.

The above prior art apparatuses suffer from some drawbacks, among which the most relevant one includes that prior art apparatuses are deployed in a single location, which may not be suitable to attract sufficient crabs for a family meal during a single crabbing session.

### BRIEF SUMMARY OF THE INVENTION

In one aspect, the present invention is directed an apparatus to attract crabs, comprising: a bait clip; and a flared tube mounted to said clip, the flared tube having a flared end and a narrower end. In another aspect, the present invention further comprises a line through said flared tube, said line having a first and second end, wherein the second end passes in through said narrower end of said flared tube and out through said flared end. In another aspect, the present invention further comprises a float attached to said second end. In another aspect of the present invention, a shape of said float is adapted to nest within the flared end of said flared tube. In another aspect of the present invention, the bait clip comprises two arms and a spring pinching an end of each of the two arms together. In another aspect of the present invention, the end of each of the two arms pinched together comprises serrated teeth. In another aspect, the present invention further comprises a swivel attached between said float and said second end of said line. In another aspect, the present invention further comprises a black coating applied to said bait clip and said flared tube. In another aspect, the present invention further comprises a swivel attached between said flared tube and said bait clip. In another aspect, the bait clip comprises a latchable ring clip comprising a latch. In another aspect, the present invention further comprises a sliding cover that slides over said latch.

In yet another aspect, the present invention is directed to an apparatus for luring crabs, comprising: a latchable ring clip comprising a latch; a flared tube mounted to said clip, the flared tube having a flared end and a narrower end; a line through said flared tube, said line having a first and second end, wherein the second end passes in through said narrower end of said flared tube and out through said flared end; and a float attached to said second end, wherein a shape of said float is adapted to nest within the flared end of said flared tube. In another aspect, the present invention further comprises a sliding cover that slides over said latch.

In yet another aspect, the present invention is directed to an apparatus for luring crabs, comprising: an alligator clip; a flared tube mounted to said clip, the flared tube having a flared end and a narrower end; a line through said flared tube, said line having a first and second end, wherein the second end passes in through said narrow end of said flared tube and out through said flared end; and a float attached to said second end, wherein a shape of said float is adapted to nest within the flared end of said flared tube. In another aspect, the present invention further comprises a sliding cover that slides over said latch.

### BRIEF DESCRIPTION OF THE DRAWINGS

FIG. 1 is a bottom view of a first embodiment of a crab lure;

FIG. 2 is a side view of an embodiment of a crab lure;

FIG. 3 is a perspective underwater view of a deployed crab lure; and

FIG. 4 is a side view of a second embodiment of a crab lure.

### DETAILED DESCRIPTION OF THE INVENTION

While no system is foolproof against the devious nature of an elusive crab, measures can be taken to attract crabs over a wider area and lure them near the surface, close to the crabber, where a waiting dip net can scoop them up. The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

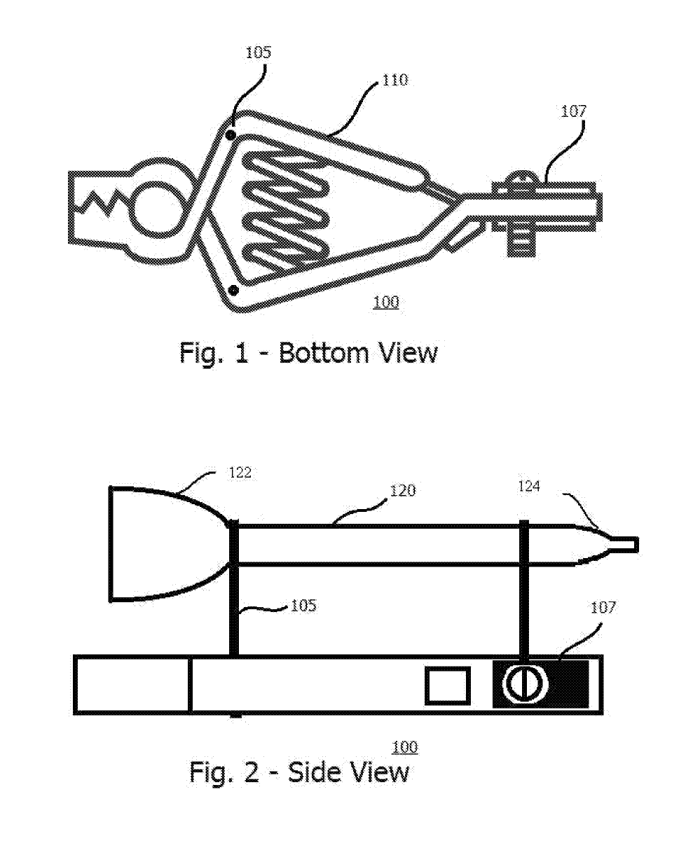

FIG. 1 is a bottom view of a crab lure that illustrates a first embodiment of the present invention. As shown in FIG. 1, the crab lure comprises a spring-loaded clip 110, having a top clip 105 and mounting clip 107 for securing a flared tube (not shown) attached to clip 110. Spring-loaded clip 110 is preferably a commonly found alligator clip having two arms, where the ends of each arm has serrated teeth, and a spring pinching the two arms together. Top clip 105 and mounting clip 107 are preferably made from spring wire, but may also be string, line, wire, rod, cord, appropriate fasteners or the like.

FIG. 2 is a side view of the first embodiment of a crab lure. As shown in FIG. 2, crab lure 100 comprises spring-loaded clip 110 and flared tube 120. Flared tube 120 comprises a flared end 122 and a narrow end 124, and can be made out of durable plastic, nylon, or similar materials. Flared tube 120 is attached to spring-loaded clip 110 via top clip 105 and/or mounting clip 107. Flared tube 120, spring-loaded clip 110, top clip 105 and mounting clip 107 preferably include a black coating that does not alarm the prey.

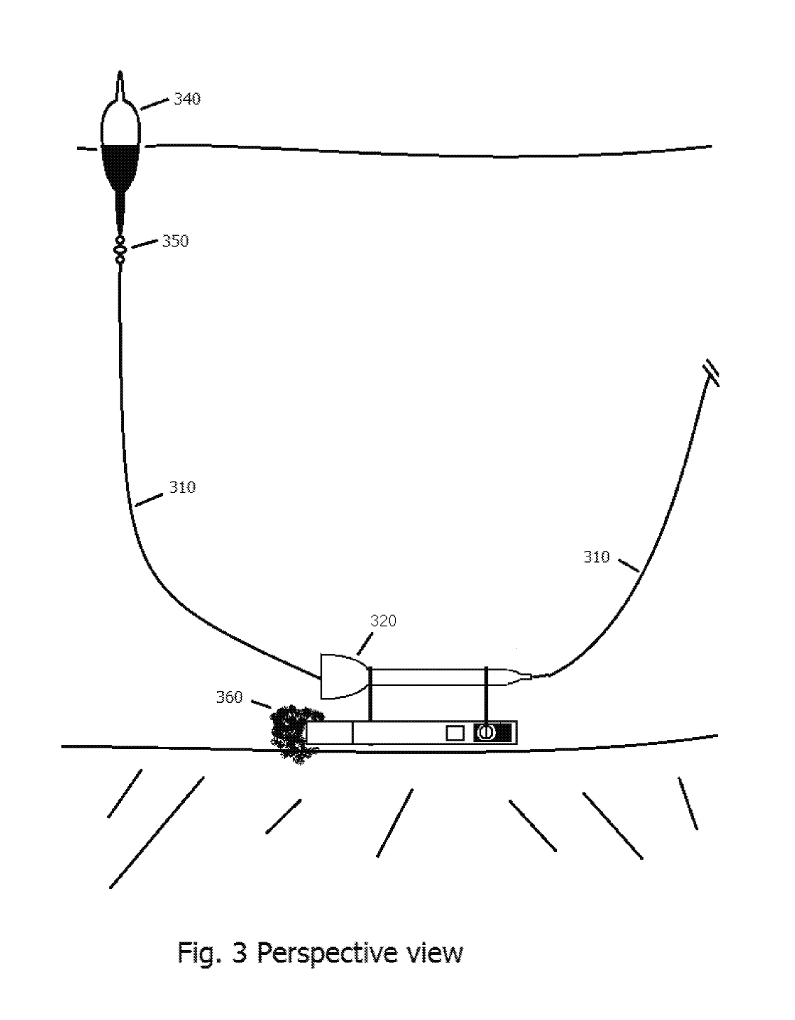

FIG. 3 is a perspective underwater view of a deployed crab lure. FIG. 3 illustrates a line 310 having two ends, where one end is threaded through a flared tube of crab lure 320 and the other end of line 310 is preferably attached a float 340 via a swivel 350. The flared end and diameter of the flared tube of lure 320 preferably has sufficient volume such that swivel 350 and a bottom portion of float 340 can be inserted into the flared tube, thereby partially nesting said float 340 and swivel 350 inside of said flared tube. Such partial nesting feature becomes advantageous when deploying the crab lure 320, particularly when casting said system using a fishing rod. Float 340 may possess sufficient buoyancy to suspend baited crab lure 320, bait 360, and a latched, hungry crab.

During operation, a crabber will place bait 360 within the spring-loaded clip 110 and cast crab lure 320 into the water at a desired location. For convenience sake, the crabber may use an ordinary fishing rod, reel and fishing line for line 310, which will enable the crabber to more easily cast crab lure 320 some distance away from the crabber's standing position. As crab lure strikes the surface of the water, the line will develop slack. Flared tube with baited, spring-loaded clip 320 will gradually slide freely down the line, toward the bottom, as shown in FIG. 3, leaving float 340 at the surface. Next, the crabber observes float 340 or any tension on line 310 for any indication of activity by hungry crabs latching onto the bait. When a crab grabs the bait with its claws, the movement of float 340 and/or tension on line 310 will let the crabber know that a crab has latched onto the bait. If the crabber is using a fishing rod, the tension of a feeding crab may be indicated by bending of the rod tip. At this moment, the crabber will slowly retrieve crab lure 320 and the feeding crab by slowly pulling in line 310, preferably by reeling in the line. As the line is slowly retrieved, lure 320 with feeding crab is gently raised from the bottom toward float 340. As float approaches the crabber's location, and the crab nears the surface, the crab is brought close enough to the crabber, but should be kept subtly beneath the surface, where the crabber can easily net the crab without the crab sensing danger.

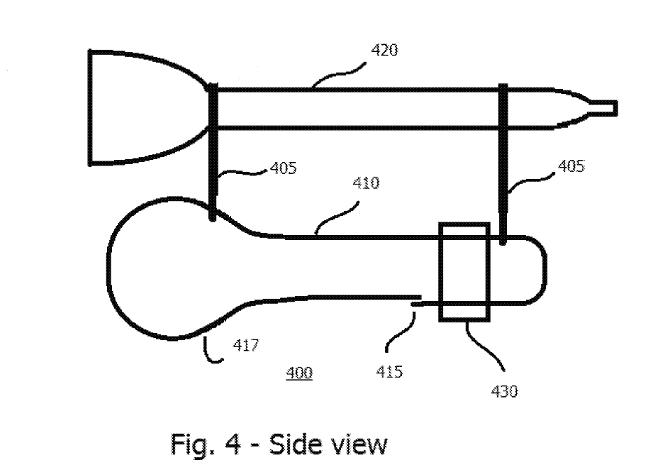

FIG. 4 is a side view of a second embodiment of a crab lure 400. As shown in FIG. 4, crab lure 400 comprises a latchable ring 410 having a latch 415 and a ring portion 417, flared tube 420, bindings 405 and sliding cover 430. Latchable ring 410 can be a commonly manufactured item, such as a shower curtain hook with spring wire and a latch fastener, e.g., a Bradley shower curtain hook, model number: 9536-000000. Latchable ring 410 can be made out of stainless steel, brass, nickel, or other material of suitable compressive/tensile strength to puncture and hold bait, while flexible enough to retain shape when opening/closing. Flared tube 420 is the same as flared tube 120 described in connection with the first preferred embodiment. Flared tube 420 is attached to latchable ring 420 via bindings 405, which preferably comprises twisted wire. Sliding cover 430 is preferably rubber or other elastomeric material used to prevent latchable ring 410 from opening.

During operation, the crabber will open latchable ring 410 and thread bait onto ring portion 417, and then close ring 410. The crabber can then move sliding cover 430 over latch 415, thereby ensuring that bait will not be removed by the crab. Then the crabber can deploy the device as described above in connection with the first embodiment.

The advantage of the present invention enables the crabber to cover a greater bottom surface area by casting the lure in various directions. In addition, crab lure 400 enables the crabber to lift bait from the bottom, while allowing the crab to freely move with the bait, and away from obstructions encountered on the bottom. Finally, since the bait is lifted, crab lure 400 prevents the bait from being dragged on the bottom and potentially damaged or released from the baiting apparatus.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed is:

1. An apparatus for luring crabs, comprising:
a bait clip; and
a flared tube mounted to said clip, the flared tube having a flared end and a narrower end.

2. The apparatus of claim 1, further comprising a line through said flared tube, said line having a first and second end, wherein the second end passes in through said narrower end of said flared tube and out through said flared end.

3. The apparatus of claim 2, further comprising a float attached to said second end.

4. The apparatus of claim 3, wherein a shape of said float is adapted to nest within the flared end of said flared tube.

5. The apparatus of claim 4, wherein the bait clip comprises two arms and a spring pinching an end of each of the two arms together.

6. The apparatus of claim 5, wherein the end of each of the two arms pinched together comprises serrated teeth.

7. The apparatus of claim 3, further comprising a swivel attached between said float and said second end of said line.

8. The apparatus of claim 7, further comprising a black coating applied to said bait clip and said flared tube.

9. The apparatus of claim 8, further comprising a swivel attached between said flared tube and said bait clip.

10. The apparatus of claim 1, wherein the bait clip comprises a latchable ring clip comprising a latch.

11. The apparatus of claim 10, further comprising a sliding cover that slides over said latch.

12. An apparatus for luring crabs, comprising:
a latchable ring clip comprising a latch;
a flared tube mounted to said clip, the flared tube having a flared end and a narrower end;
a line through said flared tube, said line having a first and second end, wherein the second end passes in through said narrower end of said flared tube and out through said flared end; and
a float attached to said second end, wherein a shape of said float is adapted to nest within the flared end of said flared tube.

13. The apparatus of claim 12, further comprising a sliding cover that slides over said latch.

14. An apparatus for luring crabs, comprising:
an alligator clip;
a flared tube mounted to said clip, the flared tube having a flared end and a narrower end;
a line through said flared tube, said line having a first and second end, wherein the second end passes in through said narrow end of said flared tube and out through said flared end; and
a float attached to said second end, wherein a shape of said float is adapted to nest within the flared end of said flared tube.

15. The apparatus of claim 14, further comprising a sliding cover that slides over said latch.
